(19) United States
(12) Patent Application Publication
(10) Pub. No.: US 2025/0300564 A1
(43) Pub. Date: Sep. 25, 2025

(54) POWER CONVERTER

(71) Applicant: Delta Electronics, Inc., Taoyuan City (TW)

(72) Inventors: Zhongwang Yang, Shanghai (CN); Teng Liu, Shanghai (CN); Xueliang Chang, Shanghai (CN)

(21) Appl. No.: 19/082,526

(22) Filed: Mar. 18, 2025

(30) Foreign Application Priority Data
Mar. 19, 2024 (CN) 202410315691.8

(51) Int. Cl. H02M 3/158; H02M 1/38; H02M 3/00

(52) U.S. Cl. CPC H02M 3/1586; H02M 1/38; H02M 3/01

(57) ABSTRACT

A power converter includes a front-stage conversion circuit and a rear-stage conversion circuit. The front-stage conversion circuit includes a buck circuit and an auxiliary circuit. The buck circuit includes a first inductor, a first switch and a first capacitor. A first terminal of the first inductor is electrically connected to an input positive terminal of the buck circuit through the first switch. A second inductor of the auxiliary circuit and the first inductor are negative coupling. The rear-stage conversion circuit includes a resonant capacitor, a first output inductor and a second output inductor. A dot-marked terminal of the first output inductor is connected with a non-dot terminal of the second output inductor and electrically connected with an output positive terminal of the power converter. The auxiliary circuit is electrically connected between an input negative terminal of the buck circuit and the resonant capacitor of the rear-stage conversion circuit.

### CROSS-REFERENCE TO RELATED APPLICATION

This application claims priority to China Patent Application No. 202410315691.8, filed on Mar. 19, 2024, the entire contents of which are incorporated herein by reference for all purposes.

### FIELD OF THE INVENTION

The present disclosure relates to a power source technology, and more particularly to power converter.

### BACKGROUND OF THE INVENTION

In a conventional non-isolated power converter, a two-stage circuitry topology is usually used to achieve the voltage reduction requirement with a high transformation ratio. That is, the power converter includes a front-stage conversion circuit and a rear-stage conversion circuit. The front-stage conversion circuit has a buck circuitry topology. The rear-stage conversion circuit has a parallel 2-phase buck circuitry topology.

FIG. 1 is a schematic circuit diagram illustrating the architecture of a first conventional non-isolated power converter. As shown in FIG. 1, the power converter 10 includes a front-stage conversion circuit 100 and a rear-stage conversion circuit 101. The front-stage conversion circuit 100 has a buck circuitry topology. The rear-stage conversion circuit has an asymmetric 2-phase buck circuitry topology with an expandable duty cycle. The rear-stage conversion circuit 101 uses a parallel buck circuit to reduce the current stress on each transistor. In addition, the rear-stage conversion circuit 101 drives the switches of each phase buck circuit to reduce the current ripple by controlling the switching duty cycle with 180-degree phase shift. However, the front-stage conversion circuit 100 and the rear-stage conversion circuit 101 of the power converter 10 adopt hard switching technologies. Consequently, the switching loss is high, and the energy transmission efficiency is not satisfied.

FIG. 2 is a schematic circuit diagram illustrating the architecture of a second conventional non-isolated power converter. As shown in FIG. 2, the power converter 11 includes a front-stage conversion circuit 110 and a rear-stage conversion circuit 111. Similarly, the front-stage conversion circuit 110 has a buck circuitry topology. However, the rear-stage conversion circuit 111 has a resonant two-stage asymmetric circuitry topology. Due to the resonant two-stage asymmetric circuitry topology, the rear-stage conversion circuit 111 can achieve the zero-current switching purpose and the zero-voltage switching purpose. When compared with the power converter 10 of FIG. 1, the switching loss of the power converter 11 of FIG. 2 is further reduced, and the energy transmission efficiency is enhanced. However, the front-stage conversion circuit 110 of the power converter 11 is not optimized. Since the front-stage conversion circuit 110 still adopts the hard switching technology, the switching loss is still high, and the energy transmission efficiency is limited.

Therefore, there is a need of providing an improved power converter in order to overcome the drawbacks of the conventional technologies.

### SUMMARY OF THE INVENTION

The present disclosure provides a power converter. The power converter includes a front-stage conversion circuit and a rear-stage conversion circuit. In a buck circuit of the front-stage conversion circuit, a first inductor and a second inductor of an auxiliary circuit are negative coupling In the rear-stage conversion circuit, the dot-marked terminal of one of a first output inductor and a second output inductor is connected with the non-dot terminal of the other of the first output inductor and the second output inductor. Consequently, the large inductance of the inductor in the front-stage conversion circuit can be offset. In response to the leakage inductances of the first inductor and the second inductor in the front-stage conversion circuit, the parasitic inductance in the wiring and the resonance generated by the resonant capacitor, zero-current switching functions of the switches in the front-stage conversion circuit can be achieved, and the energy transfer efficiency of the power converter will be enhanced.

In accordance with an aspect of the present disclosure, a power converter is provided. The power converter includes a front-stage conversion circuit and a rear-stage conversion circuit. The front-stage conversion circuit includes a buck circuit and an auxiliary circuit. The buck circuit includes a first inductor, a first switch and a first capacitor. The auxiliary circuit includes a second inductor. A first terminal of the first inductor is electrically connected to an input positive terminal of the buck circuit through the first switch. A second terminal of the first inductor is electrically connected to an output positive terminal of the buck circuit. The first capacitor is electrically connected between the output positive terminal and an output negative terminal of the buck circuit. The second inductor of the auxiliary circuit and the first inductor are negative coupling. The rear-stage conversion circuit includes a resonant capacitor, a first output inductor and a second output inductor. The first output inductor and the second output inductor are negative coupling. A dot-marked terminal of the first output inductor is connected with a non-dot terminal of the second output inductor and electrically connected with an output positive terminal of the power converter. An input positive terminal of the rear-stage conversion circuit is electrically connected to the output positive terminal of the buck circuit. An input negative terminal of the rear-stage conversion circuit is electrically connected to the output negative terminal of the buck circuit. The auxiliary circuit is electrically connected between an input negative terminal of the buck circuit and the resonant capacitor of the rear-stage conversion circuit.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the architecture of a first conventional non-isolated power converter;

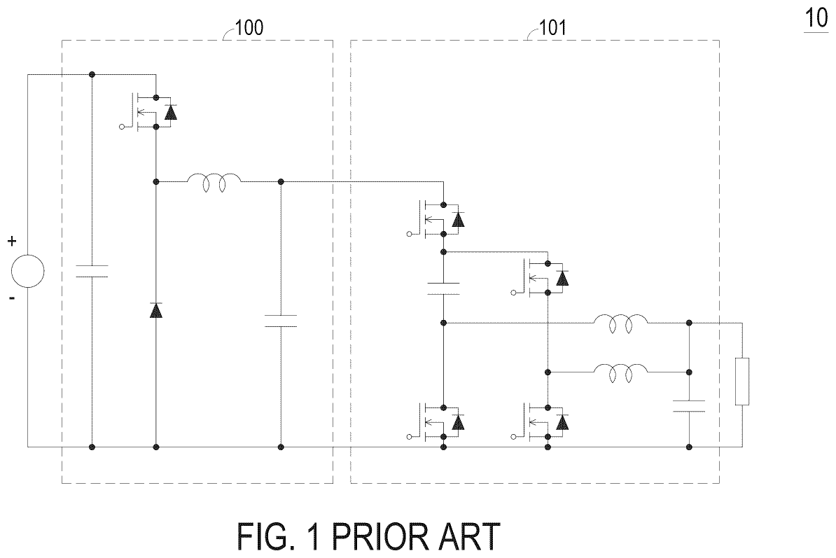

FIG. 2 is a schematic circuit diagram illustrating the architecture of a second conventional non-isolated power converter;

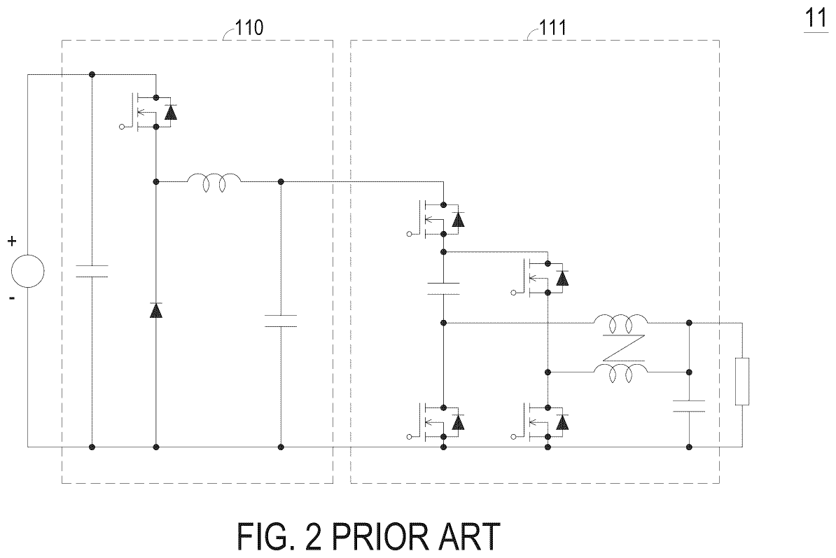

FIG. 3 is a schematic circuit diagram illustrating the architecture of a power converter according to a first embodiment of the present disclosure;

FIG. 4 is a schematic circuit diagram illustrating associated current paths of the power converter shown in FIG. 3, wherein the power converter is configured as a first resonant network;

FIG. 5 is a schematic circuit diagram illustrating associated current paths of the power converter shown in FIG. 3, wherein the power converter is configured as a second resonant network;

FIG. 6 is a schematic timing waveform diagram illustrating associated signals of the power converter shown in FIG. 3 in a first situation;

FIG. 7 is a schematic timing waveform diagram illustrating associated signals of the power converter shown in FIG. 3 in a second situation;

FIG. 8 is a schematic timing waveform diagram illustrating associated signals of the power converter shown in FIG. 3 in a third situation;

FIG. 9 is a schematic timing waveform diagram illustrating associated signals of the power converter shown in FIG. 3 in a fourth situation;

FIG. 10 is a schematic circuit diagram illustrating the architecture of a power converter according to a second embodiment of the present disclosure;

FIG. 11 is a schematic circuit diagram illustrating associated current paths of the power converter shown in FIG. 10, wherein the power converter is configured as a third resonant network;

FIG. 12 is a schematic circuit diagram illustrating associated current paths of the power converter shown in FIG. 10, wherein the power converter is configured as a fourth resonant network;

FIG. 13 is a schematic timing waveform diagram illustrating associated signals of the power converter shown in FIG. 10;

FIG. 14 is a schematic circuit diagram illustrating the architecture of a power converter according to a third embodiment of the present disclosure;

FIG. 15 is a schematic circuit diagram illustrating associated current paths of the power converter shown in FIG. 14, wherein the power converter is configured as a fifth resonant network;

FIG. 16 is a schematic circuit diagram illustrating associated current paths of the power converter shown in FIG. 14, wherein the power converter is configured as a sixth resonant network; and

FIG. 17 is a schematic timing waveform diagram illustrating associated signals of the power converter shown in FIG. 14.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

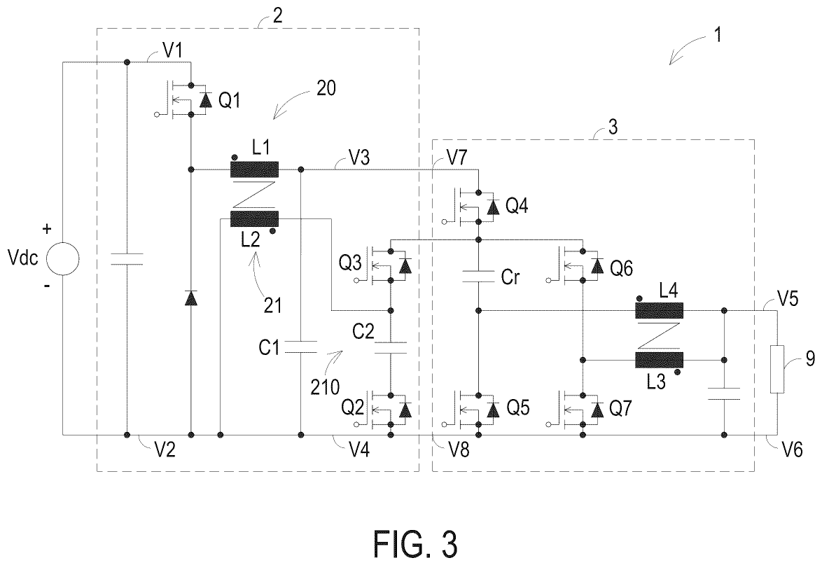

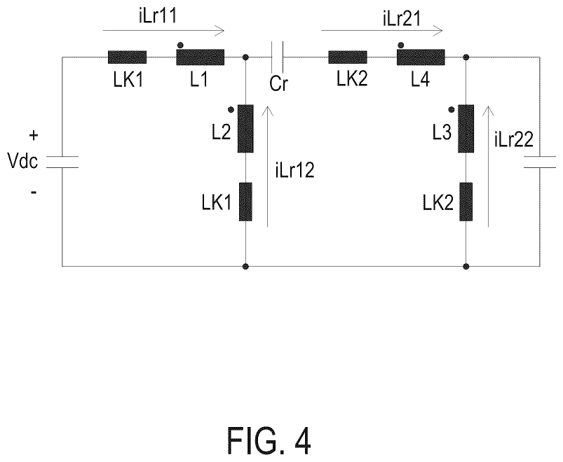

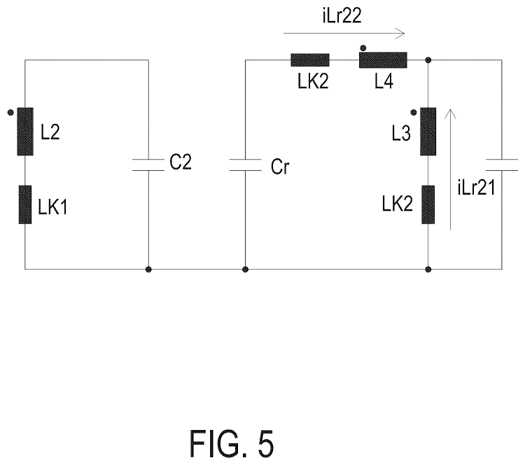

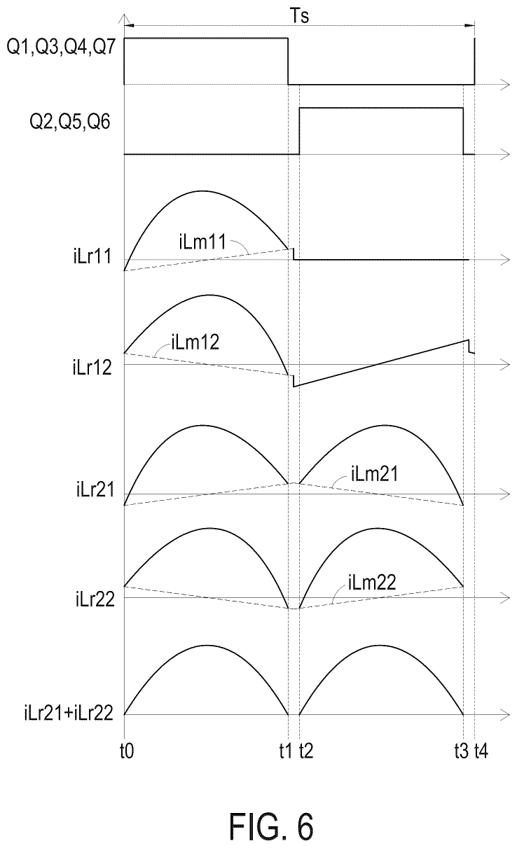

Please refer to FIGS. 3, 4, 5 and 6. FIG. 3 is a schematic circuit diagram illustrating the architecture of a power converter according to a first embodiment of the present disclosure. FIG. 4 is a schematic circuit diagram illustrating associated current paths of the power converter shown in FIG. 3, wherein the power converter is configured as a first resonant network. FIG. 5 is a schematic circuit diagram illustrating associated current paths of the power converter shown in FIG. 3, wherein the power converter is configured as a second resonant network. FIG. 6 is a schematic timing waveform diagram illustrating associated signals of the power converter shown in FIG. 3 in a first situation.

The power converter 1 is electrically connected with an input power source Vdc and a load 9. By the power converter 1, the electric power from the power source Vdc is converted into regulated power for the load 9. In this embodiment, the power converter 1 includes a front-stage conversion circuit 2 and a rear-stage conversion circuit 3.

The front-stage conversion circuit 2 includes a buck circuit 20 and an auxiliary circuit 21.

The buck circuit 20 includes a positive input terminal V1, a negative input terminal V2, a positive output terminal V3, a negative output terminal V4, a first inductor L1, a first switch Q1 and a first capacitor C1. The input positive terminal V1 and the input negative terminal V2 of the buck circuit 20 are electrically connected to the power supply positive terminal and the power supply negative terminal of the input power source Vdc, respectively. The first terminal of the first inductor L1 is electrically connected to the input positive terminal V1 of the buck circuit 20 through the first switch Q1. The second terminal of the first inductor L1 is electrically connected to the output positive terminal V3 of the buck circuit 20. The first capacitor C1 is electrically connected between the output positive terminal V3 and the output negative terminal V4 of the buck circuit 20. The negative input terminal V2 of the buck circuit 20 is electrically connected with the negative output terminal V4 of the buck circuit 20. The auxiliary circuit 21 includes a second inductor L2. In addition, the second inductor L2 of the auxiliary circuit 21 and the first inductor L1 are negative coupling.

The rear-stage conversion circuit 3 includes a resonant capacitor Cr, a first output inductor L3 and a second output inductor L4. The dot-marked terminal of one of the first output inductor L3 and the second output inductor L4 is connected with the non-dot terminal of the other of the first output inductor L3 and the second output inductor L4. For example, the dot-marked terminal of the first output inductor L3 is connected with the non-dot terminal of the second output inductor L4. The first output inductor L3 and the second output inductor L4 are negative coupling. In addition, the first output inductor L3 and the second output inductor L4 are electrically connected with an output positive terminal V5 of the power converter 1. An input positive terminal V7 of the rear-stage conversion circuit 3 is electrically connected to the output positive terminal V3 of the buck circuit 20. An input negative terminal V8 of the rear-stage conversion circuit 3 is electrically connected to the output negative terminal V4 of the buck circuit 20.

In this embodiment, the auxiliary circuit 21 is electrically connected between the input negative terminal V2 of the buck circuit 20 and the resonant capacitor Cr of the rear-stage conversion circuit 3.

As shown in FIG. 6, the time interval between the time point to and the time point t4 is equal to one switching period Ts. In addition, the first switch Q1 is operated at an operating frequency. In a time interval no longer than one half of each switching period Ts, a resonant network is defined in the power converter 1. The resonant network includes the first inductor L1, the second inductor L2, the resonant capacitor Cr, the first output inductor L3 and the second output inductor L4. Furthermore, the power converter 1 has a resonant frequency and a resonant period related to the resonant capacitance Cr, wherein the resonant period is higher than or equal to the switching period Ts.

In an embodiment, resonant currents flow through the first output inductor L3 and the second output inductor L4, and the frequency of the resonant current is lower than the operating frequency of the first switch Q1. The switching period Ts is divided into a first sub-period and a second sub-period, and the first sub-period is earlier than the second sub-period. In the first sub-period, resonant currents flow through the first output inductor L3 and the second output inductor L4, and the frequency of the resonant current is lower than the operating frequency of the first switch Q1. The resonant currents flow to the load 9 through the output positive terminal V5 and the output negative terminal V6 of the power converter 1 in order to transfer electric energy to the load 9. In the second sub-period, the resonant current flowing through one of the first inductor L1 and the second inductor L2 is zero, and twice the excitation current flows through the other of the first inductor L1 and the second inductor L2.

In an embodiment, the auxiliary circuit 21 further includes a series branch 210. The first terminal of the series branch 210 is electrically connected with the output negative terminal V4 of the buck circuit 20. The second terminal of the series branch 210 is electrically connected with the first terminal of the resonant capacitor Cr. From the first terminal to the second terminal of the series branch 210, the series branch 210 includes a second switch Q2, a second capacitor C2 and a third switch Q3 sequentially connected in series. The first terminal of the second inductor L2 is electrically connected with the input negative terminal V2 of the buck circuit 20. The second terminal of the second inductor L2 is electrically connected to a node between the second capacitor C2 and the third switch Q3. In addition, the second terminal of the resonant capacitor Cr is electrically connected with the dot-marked terminal of the second output inductor L4. The input negative terminal V8 of the rear-stage conversion circuit 3 is electrically connected with the output negative terminal V6 of the power converter 1.

In an embodiment, the first inductor L1 and the second inductor L2 are respectively two windings of a transformer, and the two windings are negative coupling. Similarly, the first output inductor L3 and the second output inductor L4 are respectively two windings of the transformer, and these two windings are negative coupling.

In an embodiment, the rear-stage conversion circuit 3 further includes a fourth switch Q4, a fifth switch Q5, a sixth switch Q6 and a seventh switch Q7. The first terminal of the fourth switch Q4 is electrically connected with the input positive terminal V7 of the rear-stage conversion circuit 3. The second terminal of the fourth switch Q4 is electrically connected with the first terminal of the resonant capacitor Cr. The first terminal of the fifth switch Q5 is electrically connected with the second terminal of the resonant capacitor Cr. The second terminal of the fifth switch Q5 is electrically connected with the input negative terminal V8 of the rear-stage conversion circuit 3. The first terminal of the sixth switch Q6 is electrically connected with the first terminal of the resonant capacitor Cr. The second terminal of the sixth switch Q6 is electrically connected with the first terminal of the seventh switch Q7. The second terminal of the seventh switch Q7 is electrically connected with the negative output terminal V6 of the power converter 1.

In an embodiment, the first switch Q1, the third switch Q3, the fourth switch Q4 and the seventh switch Q7 receive a first control signal, and the second switch Q2, the fifth switch Q5 and the sixth switch Q6 receive a second control signal. As shown in FIG. 6, the phase shift between the first control signal and the second control signal is 180 degrees. Similarly, each of the second switch Q2, the third switch Q3, the fourth switch Q4, the fifth switch Q5, the sixth switch Q6 and the seventh switch Q7 has the switching period Ts. In addition, the turn-on duration of each of the first switch Q1, the second switch Q2, the third switch Q3, the fourth switch Q4, the fifth switch Q5, the sixth switch Q6 and the seventh switch Q7 is smaller than one half of the switching period Ts.

In an embodiment, the switching period Ts includes two dead time segments. One of the two dead time segments is between the first sub-period and the second sub-period, e.g., the time interval between the time point t1 and the time point t2 as shown in FIG. 6. The second sub-period is followed by the other of the dead time segments, e.g., the time interval between the time point t3 and the time point t4. The time lengths of the two dead time segments are equal. In the two dead time segments, the first switches Q1, the second switch Q2, the third switch Q3, the fourth switch Q4, the fifth switch Q5, the sixth switch Q6 and the seventh switch Q7 are turned off. In addition, the parasitic capacitors of the first switch Q1, the third switch Q3, the fourth switch Q4, the seventh switch Q7, the second switch Q2, the fifth switch Q5 and the sixth switch Q6 are charged or discharged in response to the excitation currents flowing through the first inductor L1, the second inductor L2, the first output inductor L3 and the second output inductor L4.

In an embodiment, the turn ratio of the windings of the first inductor L1 and the second inductor L2 is 1:1.

Hereinafter, the operations of the power converter 1 will be illustrated with reference to FIGS. 3, 4, 5 and 6.

Please refer to FIG. 6. In the time interval between the time point to and the time point t1, the first switch Q1, the third switch Q3, the fourth switch Q4 and the seventh switch Q7 are turned on, and the second switch Q2, the fifth switch Q5 and the sixth switch Q6 are turned off. Meanwhile, the simplified circuitry topology of the power converter 1 can be seen in FIG. 4, and the power converter 1 is configured as a first resonant network.

As shown in FIG. 4, the non-dot terminal of the first inductor L1 and the dot-marked terminal of the second inductor L2 are short-circuited. In order to simplify the analysis, the influence of the first capacitor C1 is ignored here. There is a plurality of resonant currents in the power converter 1. The resonant current iLr11 flows through the first inductor L1. The resonant current iLr22 flows through the second inductor L2. The resonant current iLr21 flows through the first output inductor L3. The resonant current iLr22 flows through the second output inductor L4.

In addition, each resonant current includes two parts, i.e., a load current and an excitation current. The excitation current is determined according to the voltage across the two terminals of the inductor and the magnetizing inductance. In other words, the resonant current iLr11 includes the load current and the excitation current iLm11, the resonant current iLr12 includes the load current and the excitation current iLm12, the resonant current iLr21 includes the load current and the excitation current iLm21, and the resonant current iLr22 includes the load current and the excitation current iLm22. Due to the resonance of the resonant capacitor Cr and the resonant inductor Lr, the resonant currents iLr11, iLr12, iLr21 and iLr22 are generated. The equivalent resonant inductance Lr may be expressed as: Lr=Lk1/2+2×Lk2+Leq, where Lk1 is the leakage inductance of one of the first inductor L1 and the second inductor L2, Lk2 is the leakage inductance of one of the first output inductor L3 and the second output inductor L4, and Leq is the equivalent inductance about the parasitic inductance in the primary side traces of the front-stage conversion circuit 2 and the parasitic inductance in the secondary side traces of the rear-stage conversion circuit 3.

Under this circumstance, the non-dot terminal of the first inductor L1 and the dot-marked terminal of the second inductor L2 are connected with each other directly, and the dot-marked terminal of the first output inductor L3 and the non-dot terminal of the second output inductor L4 are connected with each other directly. Consequently, the excitation current iLm11 is equal to the reverse excitation current iLm12, the excitation current iLm21 is equal to the reverse excitation current iLm22, and the resonant current iLr11 is equal to the resonant current iLr12, and the resonant current iLr21 is equal to the resonant current iLr22. The waveforms of these currents can be seen in FIG. 6.

In the equivalent circuit, the magnetizing inductances of the first inductor L1, the second inductor L2, the first output inductor L3 and the second output inductor L4 can be cancelled out. In addition, the leakage inductances of the first inductor L1, the second inductor L2, the first output inductor L3 and the second output inductor L4 can resonate with the resonant capacitor Cr. That is, in the time interval between the time point to and the time point t1, the resonance between the resonant capacitor Cr and the resonant inductor Lr of the power converter 1 generates the resonant currents iLr11, iLr12, iLr21 and iLr22. When the resonant currents iLr11, iLr12, iLr21 and iLr22 are respectively equal to the excitation currents iLm11, iLm12, iLm21 and iLm22, i.e., the load current is zero, the first switch Q1, the third switch Q3, the fourth switch Q4 and the seventh switch Q7 are turned off. Since the zero-current switching functions of these switches are achieved, the turn-off loss of the switches will be reduced, and the energy transfer efficiency of the power converter 1 will be enhanced.

In the time interval between the time point t2 and the time point t3, the second switch Q2, the fifth switch Q5 and the sixth switch Q6 are turned on, and the first switch Q1, the third switch Q3, the fourth switch Q4 and the seventh switch Q7 are turned off. Meanwhile, the simplified circuitry topology of the power converter 1 can be seen in FIG. 5, and the power converter 1 is configured as a second resonant network.

The equivalent circuit is divided into a left part and a right part. The left part includes the second inductor L2, the leakage inductance Lk1 of the second inductor L2 and the second capacitor C2. The right part includes the resonant capacitor Cr, the first output inductor L3, the leakage inductance Lk2 of the first output inductor L3, the second output inductor L4 and the leakage inductance Lk2 of the second output inductor L4.

In the circuitry of the left part, the resonant current flowing through the first inductor L1 is zero (i.e., iLr11=0) because the fourth switch Q4 is turned on. In this time interval, the second capacitor C2 discharges electricity to the second inductor L2. Consequently, the resonant current iLr12 flowing through the second inductor L2 increases linearly. The waveforms of these currents can be seen in FIG. 6. When the winding current of the second inductor L2 is equal to twice the excitation current iLm12 (i.e., the load current is zero), the second switch Q2, the fifth switch Q5 and the sixth switch Q6 are turned off. Since the zero-current switching functions of these switches are achieved, the turn-off loss of the switches will be reduced, and the energy transfer efficiency of the power converter 1 will be enhanced.

In the circuitry of the right part, the resonant capacitor Cr discharges electricity to the first output inductor L3 and the second output inductor L4. The circuitry of the right part is similar to that in the time interval between the time point to and the time point t1. Since the dot-marked terminal of the first output inductor L3 and the non-dot terminal of the second output inductor L4 are electrically connected with each other, the excitation current iLm21 flowing through the first output inductor L3 and the excitation current iLm22 flowing through the second output inductor L4 have the relationship: the excitation current iLm21 is equal to the reverse excitation current iLm22. In response to the resonance between the resonant capacitor Cr and the resonant inductor Lr, the resonant currents iLr21 and iLr22 are generated. The resonant inductance Lr may be expressed as: Lr=2×Lk2+Leq, where Lk2 is the leakage inductance of one of the first output inductor L3 and the second output inductor L4, and Leq is the equivalent inductance about the parasitic inductance in the primary side traces of the front-stage conversion circuit 2, the parasitic inductance in the secondary side traces of the rear-stage conversion circuit 3 and optionally the inductance of at least one external inductor (not shown). Consequently, the resonant current iLr21 flowing through the first output inductor L3 and the resonant current iLr22 flowing through the second output inductor L4 are equal. The waveforms of these currents in the time interval between the time point t2 and the time point t3 can be seen in FIG. 6.

In the equivalent circuit, the magnetizing inductances of the first output inductor L3 and the second output inductor L4 can be cancelled out. In addition, the leakage inductances of the first output inductor L3 and the second output inductor L4 can resonate with the resonant capacitor Cr. That is, in the time interval between the time point t2 and the time point t3, the resonance between the resonant capacitor Cr and the resonant inductor Lr of the power converter 1 generates the resonant currents iLr21 and iLr22. When the resonant currents iLr21 and iLr22 are respectively equal to the excitation currents iLm21 and iLm22, i.e., the load current is zero, the first switch Q1, the third switch Q3, the fourth switch Q4 and the seventh switch Q7 are turned off. Since the zero-current switching (ZCS) functions of these switches are achieved, the turn-off loss of the switches will be reduced, and the energy transfer efficiency of the power converter 1 will be enhanced.

Furthermore, in the time interval between the time point t2 and the time point t3, the voltage drop across the two terminals of the first switch Q1 is Vdc/2, the voltage drop across the two terminals of the fourth switch Q4 is Vdc/4, the voltage drop across the two terminals of the seventh switch Q7 is Vdc/4, and the voltage drop across the two terminals of the third switch Q3 is 3Vdc/4. In the beginning of the interval from time t3 to time t4, the second switch Q2, the fifth switch Q5 and the sixth switch Q6 are turned off, and the excitation currents of the first inductor L1, the second inductor L2, the first output inductor L3 and the second output inductor L4 start to freewheel. In addition, the corresponding excitation currents reversely charge the parasitic capacitances at the two terminals of each of the first switch Q1, the third switch Q3, the fourth switch Q4 and the seventh switch Q7. Consequently, the drain-source voltages of the first switch Q1, the third switch Q3, the fourth switch Q4 and the seventh switch Q7 drop. When the drain-source voltages of the first switch Q1, the third switch Q3, the fourth switch Q4 and the seventh switch Q7 drop to be lower than 50% of the initial voltage, the first switch Q1, the third switch Q3, the fourth switch Q4 and the seventh switch Q7 are turned on. Then, the next switching period is started. Consequently, the turn-on loss of the switches will be reduced, and the energy transfer efficiency of the power converter 1 will be enhanced. Furthermore, when the drain-source voltages of these switches drop to zero, the first switch Q1, the third switch Q3, the fourth switch Q4 and the seventh switch Q7 are turned on. Since the zero-voltage switching functions of these switches are achieved, the turn-on loss of the switches will be reduced, and the energy transfer efficiency of the power converter 1 will be enhanced.

As mentioned above, the turn-off loss of the switches of the power converter 1 will be reduced in response to the zero-current switching functions. The power converter 1 can be operated in different situations. The operations of the power converter 1 in some situations will be illustrated with the waveforms of FIGS. 6, 7, 8 and 9.

As shown in FIG. 6, the power converter 1 is operated in a first situation. In the first situation, the resonant period Tr1 of the power converter 1 in the time interval between the time point to and the time point t1 and the resonant period Tr2 of the power converter 1 in the time interval between the time point t2 and the time point t3 are equal, and the resonant period Tr2 of the power converter 1 is equal to the switching period Ts. Under this circumstance, it is ensured that the leakage inductances of the first inductor L1 and the second inductor L2 are much smaller than the leakage inductances of the first output inductor L3 and the second output inductor L4.

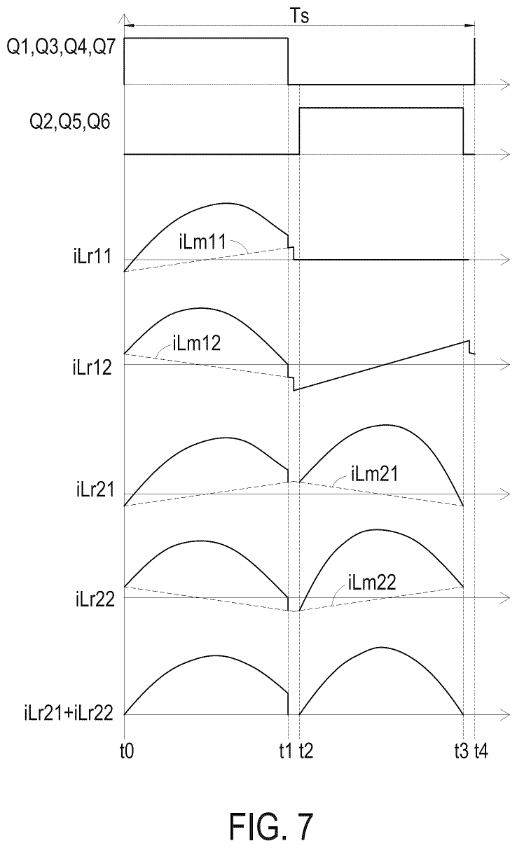

FIG. 7 is a schematic timing waveform diagram illustrating associated signals of the power converter shown in FIG. 3 in a second situation. In the second situation, the resonant period Tr1 of the power converter 1 is higher than the resonant period Tr2 of the power converter 1, and the resonant period Tr2 of the power converter 1 is equal to the switching period Ts. Under this circumstance, the leakage inductances of the first inductor L1 and the second inductor L2 are nearly equal to the leakage inductances of the first output inductor L3 and the second output inductor L4. At the time point t1, the turn-off current is greater than zero. Please refer to the waveform of FIG. 7. At the time point t1, the resonant current iLr11 is greater than the excitation current iLm11, and the resonant current iLr12 is greater than the excitation current iLm12. Consequently, the first switch Q1, the third switch Q3, the fourth switch Q4 and the seventh switch Q7 are turned off. At the time point t3, the resonant current iLr21 is equal to the excitation current iLm21, and the resonant current iLr22 is equal to the excitation current iLm22. Consequently, the second switch Q2, the fifth switch Q5 and the sixth switch Q6 are turned off.

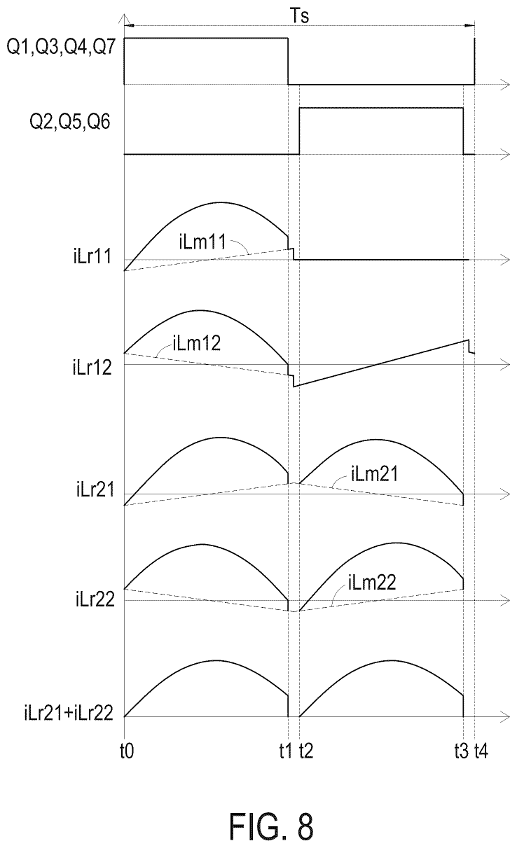

FIG. 8 is a schematic timing waveform diagram illustrating associated signals of the power converter shown in FIG. 3 in a third situation. In the third situation, the resonant period Tr1 of the power converter 1 in the time interval between the time point t0 and the time point t1 and the resonant period Tr2 of the power converter 1 in the time interval between the time point t2 and the time point t3 are equal, and the resonant period Tr2 of the power converter 1 is higher than the switching period Ts. Under this circumstance, it is ensured that the leakage inductances of the first inductor L1 and the second inductor L2 are much smaller than the leakage inductances of the first output inductor L3 and the second output inductor L4. The turn-off current at the time point t1 and the turn-off current at the time point t3 are both greater than zero. Please refer to the waveform of FIG. 8. At the time point t1, the resonant current iLr11 is greater than the excitation current iLm11, and the resonant current iLr12 is greater than the excitation current iLm12. Consequently, the first switch Q1, the third switch Q3, the fourth switch Q4 and the seventh switch Q7 are turned off. At the time point t3, the resonant current iLr21 is greater than the excitation current iLm21, and the resonant current iLr22 is greater than the excitation current iLm22. Consequently, the second switch Q2, the fifth switch Q5 and the sixth switch Q6 are turned off.

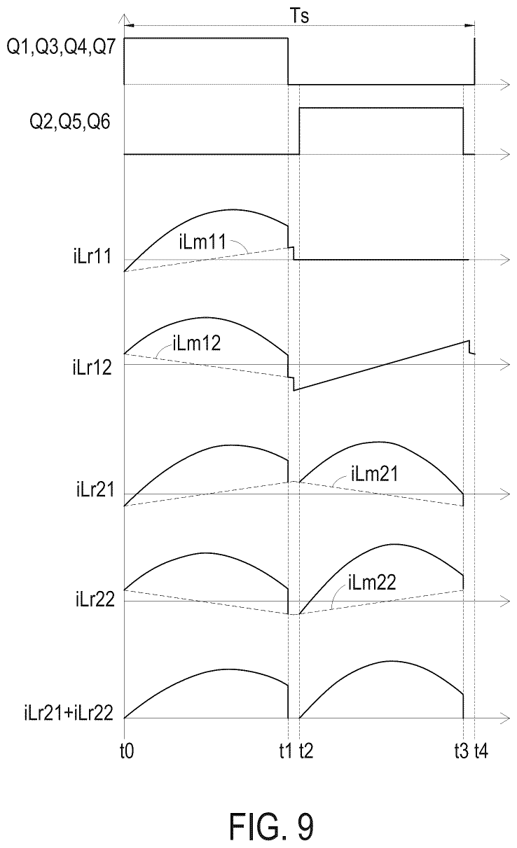

FIG. 9 is a schematic timing waveform diagram illustrating associated signals of the power converter shown in FIG. 3 in a fourth situation. The waveform shown in FIG. 9 is a variant example of the waveform shown in FIG. 8. In the fourth situation, the resonant period Tr1 of the power converter 1 is higher than the resonant period Tr2 of the power converter 1, and the resonant period Tr2 of the power converter 1 is higher than the switching period Ts. The turn-off current at the time point t1 and the turn-off current at the time point t3 are both greater than zero.

In the situations of FIGS. 7, 8 and 9, the turn-off current is greater than zero. However, since the equivalent resonant inductance is small, the turn-off loss related to the non-zero-current switching approach is still low. Consequently, the conversion efficiency of power converter 1 will not be adversely affected.

In the above embodiments, the leakage inductance generated by the coupling between the first inductor L1 and the second inductor L2, the leakage inductance generated by the coupling between the first output inductor L3 and the second output inductor L4 and the parasitic inductance in the traces are used as the resonant inductance. When the resonant period, the switching period Ts and the capacitance of the resonant capacitor Cr are taken into consideration, it is preferred that the coupling coefficient about the first inductor L1 and the second inductor L2 is less than −0.9. In case that the coupling coefficient is greater than −0.9, the leakage inductance of the first inductor L1 and the second inductor L2 is greater than 10% of their self-inductance. It means that the leakage magnetic field intensity of the magnetic core of the inductor increases. Since the core loss and the winding loss of the inductor increase, the efficiency of the power converter is reduced. In other words, it is optimal that the coupling coefficient about the first inductor L1 and the second inductor L2 is less than −0.9 and the coupling coefficient about the first output inductor L3 and the second output inductor L4 is less than −0.9.

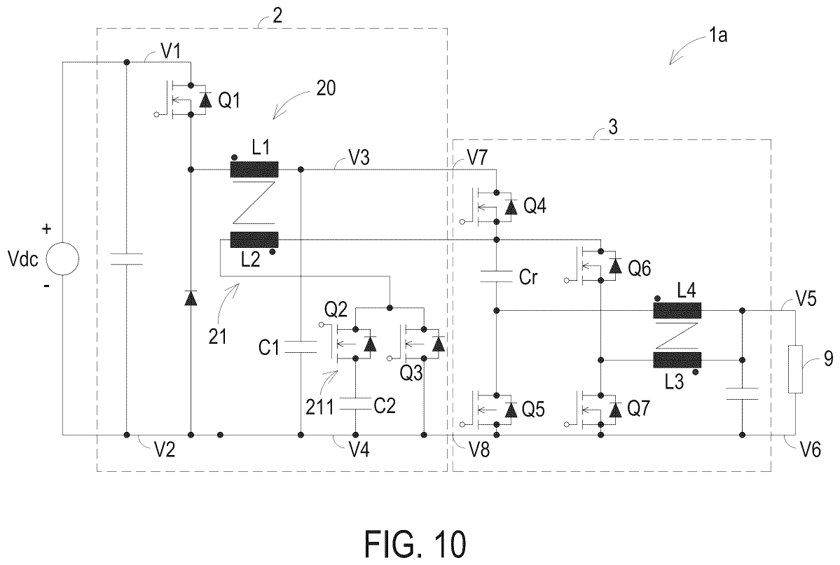

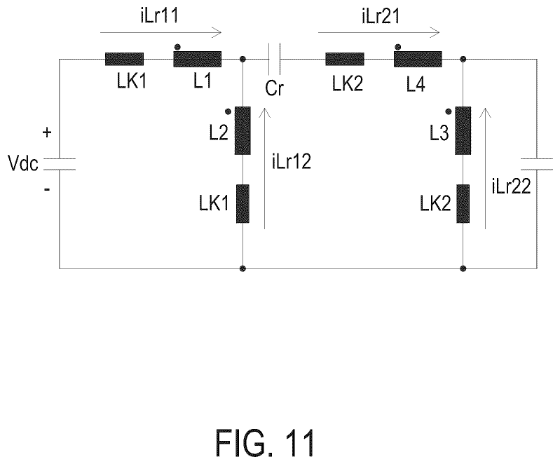

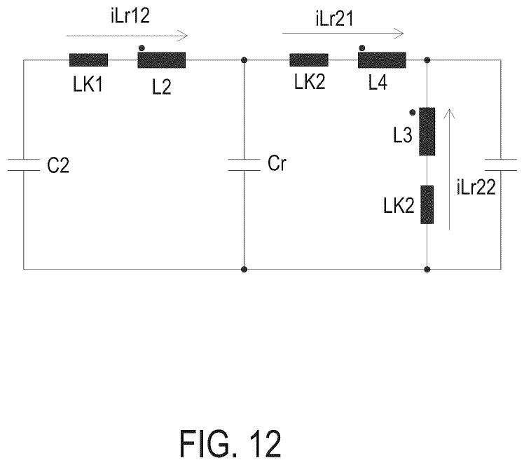

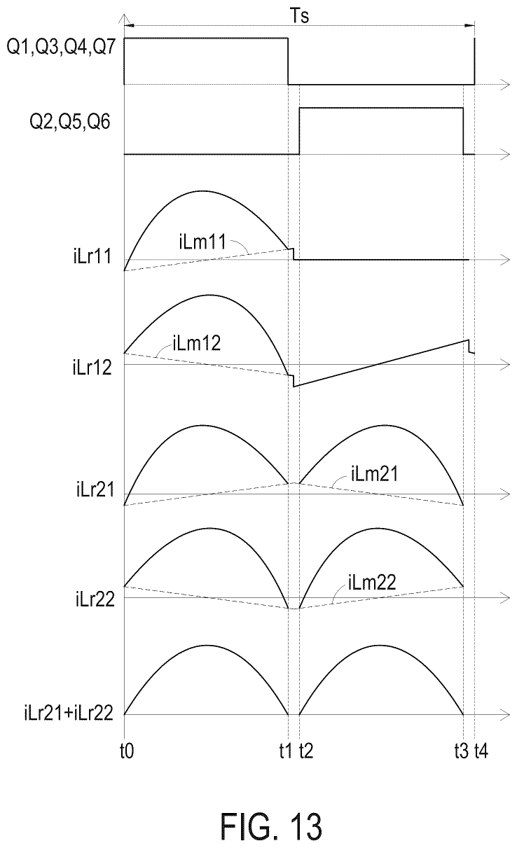

Please refer to FIGS. 10, 11, 12 and 13. FIG. 10 is a schematic circuit diagram illustrating the architecture of a power converter according to a second embodiment of the present disclosure. FIG. 11 is a schematic circuit diagram illustrating associated current paths of the power converter shown in FIG. 10, wherein the power converter is configured as a third resonant network. FIG. 12 is a schematic circuit diagram illustrating associated current paths of the power converter shown in FIG. 10, wherein the power converter is configured as a fourth resonant network. FIG. 13 is a schematic timing waveform diagram illustrating associated signals of the power converter shown in FIG. 10. Component parts and elements corresponding to those of the first embodiment are designated by identical numeral references, and detailed descriptions thereof are omitted.

In the first embodiment, the auxiliary circuit 21 in the power converter 1 of FIG. 3 includes the series branch 210. In the power converter 1a of the second embodiment, the auxiliary circuit 21 of the front-stage conversion circuit 2 is not equipped with the series branch 210. On the contrary, the auxiliary circuit 21 in the power converter 1a includes a parallel branch 211. The parallel branch 211 includes a second capacitor C2, a second switch Q2 and a third switch Q3. The second switch Q2 is connected with the second capacitor C2 in series. The series-connected structure of the second switch Q2 and the second capacitor C2 is connected with the third switch Q3 in parallel. The first terminal of the parallel branch 211 is electrically connected with the output negative terminal V4 of the buck circuit 20. The second terminal of the parallel branch 211 is electrically connected with the first terminal of the second inductor L2. In addition, the second terminal of the second inductor L2 is electrically connected with the first terminal of the resonant capacitor Cr.

In an embodiment, the first switch Q1, the third switch Q3, the fourth switch Q4 and the seventh switch Q7 receive a first control signal, and the second switch Q2, the fifth switch Q5 and the sixth switch Q6 receive a second control signal. As shown in FIG. 13, the phase shift between the first control signal and the second control signal is 180 degrees. Similarly, each of the second switch Q2, the third switch Q3, the fourth switch Q4, the fifth switch Q5, the sixth switch Q6 and the seventh switch Q7 has the switching period Ts. In addition, the turn-on duration of each of the first switch Q1, the second switch Q2 and the third switch Q3, the fourth switch Q4, the fifth switch Q5, the sixth switch Q6 and the seventh switch Q7 is smaller than one half of the switching period Ts.

Hereinafter, the operations of the power converter 1a will be illustrated with reference to FIGS. 10, 11, 12 and 13.

Please refer to FIG. 13. In the time interval between the time point t0 and the time point t1, the first switch Q1, the third switch Q3, the fourth switch Q4 and the seventh switch Q7 are turned on, and the second switch Q2, the fifth switch Q5 and the sixth switch Q6 are turned off. Meanwhile, the simplified circuitry topology of the power converter 1a can be seen in FIG. 11, and the power converter 1a is configured as a third resonant network.

As shown in FIG. 11, the non-dot terminal of the first inductor L1 and the dot-marked terminal of the second inductor L2 are short-circuited. In order to simplify the analysis, the influence of the first capacitor C1 is ignored here. There is a plurality of resonant currents in the power converter 1a. The resonant current iLr11 flows through the first inductor L1. The resonant current iLr22 flows through the second inductor L2. The resonant current iLr21 flowing through the first output inductor L3. The resonant current iLr22 flows through the second output inductor L4.

In addition, each resonant current includes two parts, i.e., a load current and an excitation current. The excitation current is determined according to the voltage across the two terminals of the inductor and the magnetizing inductance. In other words, the resonant current iLr11 includes the load current and the excitation current iLm11, the resonant current iLr12 includes the load current and the excitation current iLm12, the resonant current iLr21 includes the load current and the excitation current iLm21, and the resonant current iLr22 includes the load current and the excitation current iLm22. Due to the resonance of the resonant capacitor Cr and the resonant inductor Lr, the resonant currents iLr11, iLr12, iLr21 and iLr22 are generated. The equivalent resonant inductance Lr may be expressed as: Lr=Lk1/2+2×Lk2+Leq, where Lk1 is the leakage inductance of one of the first inductor L1 and the second inductor L2, Lk2 is the leakage inductance of one of the first output inductor L3 and the second output inductor L4, and Leq is the equivalent inductance about the parasitic inductance in the primary side traces of the front-stage conversion circuit 2 and the parasitic inductance in the secondary side traces of the rear-stage conversion circuit 3.

Under this circumstance, the non-dot terminal of the first inductor L1 and the dot-marked terminal of the second inductor L2 are connected with each other directly, and the dot-marked terminal of the first output inductor L3 and the non-dot terminal of the second output inductor L4 are connected with each other directly. Consequently, the excitation current iLm11 is equal to the reverse excitation current iLm12, the excitation current iLm21 is equal to the reverse excitation current iLm22, and the resonant current iLr21 is equal to the resonant current iLr22. The waveforms of these currents can be seen in FIG. 13.

In the equivalent circuit, the magnetizing inductances of the first inductor L1, the second inductor L2, the first output inductor L3 and the second output inductor L4 can be cancelled out. In addition, the leakage inductances of the first inductor L1, the second inductor L2, the first output inductor L3 and the second output inductor L4 can resonate with the resonant capacitor Cr. That is, in the time interval between the time point to and the time point t1, the resonance between the resonant capacitor Cr and the resonant inductor Lr of the power converter 1a generates the resonant currents iLr11, iLr12, iLr21 and iLr22. When the resonant currents iLr11, iLr12, iLr21 and iLr22 are respectively equal to the excitation currents iLm11, iLm12, iLm21 and iLm22, i.e., the load current is zero, the first switch Q1, the third switch Q3, the fourth switch Q4 and the seventh switch Q7 are turned off. Since the zero-current switching functions of these switches are achieved, the turn-off loss of the switches will be reduced, and the energy transfer efficiency of the power converter 1a will be enhanced.

In the time interval between the time point t2 and the time point t3, the second switch Q2, the fifth switch Q5 and the sixth switch Q6 are turned on, and the first switch Q1, the third switch Q3, the fourth switch Q4 and the seventh switch Q7 are turned off. Meanwhile, the simplified circuitry topology of the power converter 1a can be seen in FIG. 12, and the power converter 1a is configured as a fourth resonant network.

The equivalent circuit is divided into a left part and a right part. The left part includes the second inductor L2, the leakage inductance Lk1 of the second inductor L2 and the second capacitor C2. The right part includes the first output inductor L3, the leakage inductance Lk2 of the first output inductor L3, the second output inductor L4 and the leakage inductance Lk2 of the second output inductor L4.

In the circuitry of the right part, the resonant capacitor Cr discharges electricity to the first output inductor L3 and the second output inductor L4. The circuitry of the right part is similar to that in the time interval between the time point to and the time point t1. Since the dot-marked terminal of the first output inductor L3 and the non-dot terminal of the second output inductor L4 are electrically connected with each other, the excitation current iLm21 flowing through the first output inductor L3 and the excitation current iLm22 flowing through the second output inductor L4 have the relationship: the excitation current iLm21 is equal to the reverse excitation current iLm22. In response to the resonance between the resonant capacitor Cr and the resonant inductor Lr, the resonant currents iLr21 and iLr22 are generated. The resonant inductance Lr may be expressed as: Lr=2×Lk2+Leq, where Lk2 is the leakage inductance of one of the first output inductor L3 and the second output inductor L4, and Leq is the equivalent inductance about the parasitic inductance in the primary side traces of the front-stage conversion circuit 2, the parasitic inductance in the secondary side traces of the rear-stage conversion circuit 3 and optionally the inductance of at least one external inductor (not shown). Consequently, the resonant current iLr21 flowing through the first output inductor L3 and the resonant current iLr22 flowing through the second output inductor L4 are equal. The waveforms of these currents in the time interval between the time point t2 and the time point t3 can be seen in FIG. 13.

In the equivalent circuit, the magnetizing inductances of the first output inductor L3 and the second output inductor L4 can be cancelled out. In addition, the leakage inductances of the first output inductor L3 and the second output inductor L4 can resonate with the resonant capacitor Cr.

That is, in the time interval between the time point t2 and the time point t3, the resonance between the resonant capacitor Cr and the resonant inductor Lr of the power converter 1a generates the resonant currents iLr21 and iLr22. When the resonant currents iLr21 and iLr22 are respectively equal to the excitation currents iLm21 and iLm22, i.e., the load current is zero, the first switch Q1, the third switch Q3, the fourth switch Q4 and the seventh switch Q7 are turned off. Since the zero-current switching (ZCS) functions of these switches are achieved, the turn-off loss of the switches will be reduced, and the energy transfer efficiency of the power converter 1a will be enhanced.

As mentioned above, the capacitance of the resonant capacitor Cr is larger, and the inductance of the resonant inductor Lr is relatively smaller. Consequently, the voltage ripple of the resonant capacitor Cr is very small. Consequently, the voltage of the resonant capacitor Cr may be considered as a DC voltage.

In the circuitry of the left part, the resonant current flowing through the first inductor L1 is zero (i.e., iLr11=0) because the fourth switch Q4 is turned off. In this time interval, the second capacitor C2 discharges electricity to the second inductor L2. Consequently, the resonant current iLr12 flowing through the second inductor L2 increases linearly. The waveforms of these currents can be seen in FIG. 13. When the winding current of the second inductor L2 is equal to twice the excitation current iLm12 (i.e., the load current is zero), the second switch Q2, the fifth switch Q5 and the sixth switch Q6 are turned off. Since the zero-current switching functions of these switches are achieved, the turn-off loss of the switches will be reduced, and the energy transfer efficiency of the power converter 1a will be enhanced.

Furthermore, in the time interval between the time point t2 and the time point t3, the voltage drop across the two terminals of the first switch Q1 is Vdc/2, the voltage drop across the two terminals of the fourth switch Q4 is Vdc/4, the voltage drop across the two terminals of the seventh switch Q7 is Vdc/4, and the voltage drop across the two terminals of the third switch Q3 is 3Vdc/4. In the beginning of the interval from time t3 to time t4, the second switch Q2, the fifth switch Q5 and the sixth switch Q6 are turned off, and the excitation currents of the first inductor L1, the second inductor L2, the first output inductor L3 and the second output inductor L4 start to freewheel. In addition, the corresponding excitation currents reversely charge the parasitic capacitances at the two terminals of each of the first switch Q1, the third switch Q3, the fourth switch Q4 and the seventh switch Q7. Consequently, the drain-source voltages of the first switch Q1, the third switch Q3, the fourth switch Q4 and the seventh switch Q7 drop. When the drain-source voltages of the first switch Q1, the third switch Q3, the fourth switch Q4 and the seventh switch Q7 drop to be lower than 50% of the initial voltage, the first switch Q1, the third switch Q3, the fourth switch Q4 and the seventh switch Q7 are turned on. Then, the next switching period is started. Consequently, the turn-on loss of the switches will be reduced, and the energy transfer efficiency of the power converter 1a will be enhanced. Furthermore, when the drain-source voltages of these switches drop to zero, the first switch Q1, the third switch Q3, the fourth switch Q4 and the seventh switch Q7 are turned on. Since the zero-voltage switching functions of these switches are achieved, the turn-on loss of the switches will be reduced, and the energy transfer efficiency of the power converter 1a will be enhanced.

Like the power converter 1 shown in FIG. 3, the power converter 1a of this embodiment can be operated in four situations shown in FIGS. 6, 7, 8 and 9. The operations of the power converter 1a in some situations will be illustrated with the waveforms of FIG. 13 as well as FIGS. 6, 7, 8 and 9.

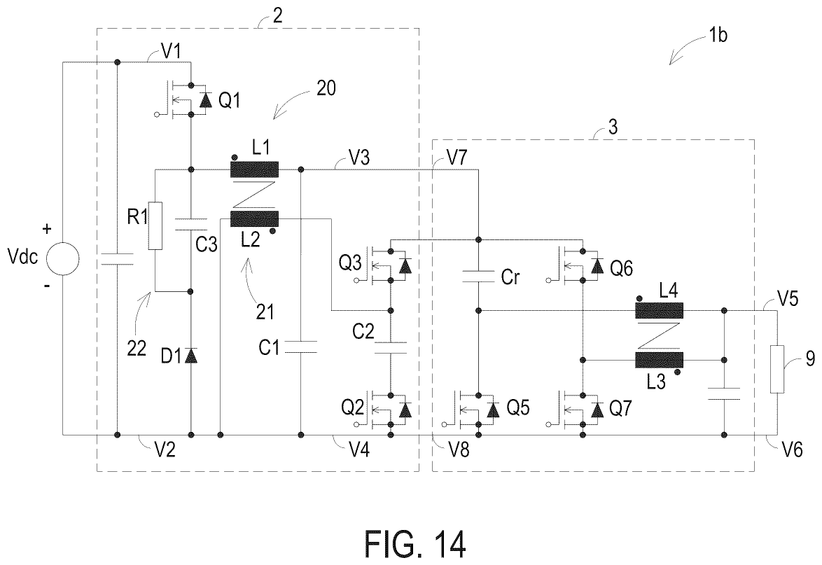

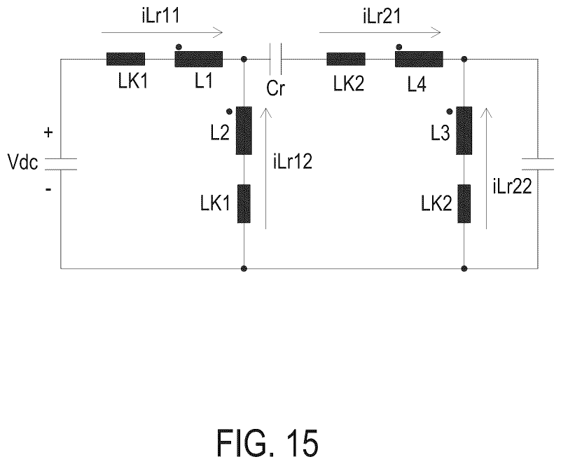

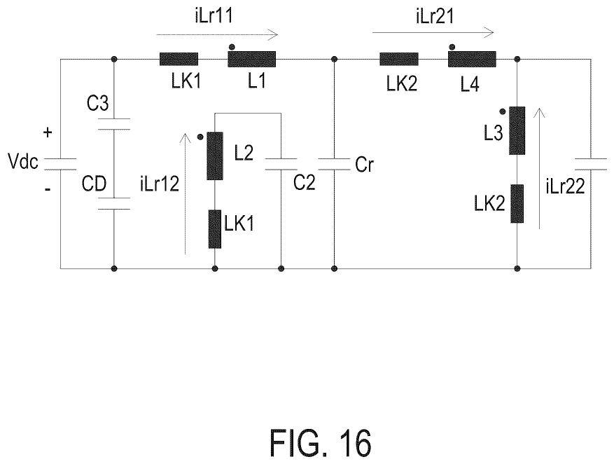

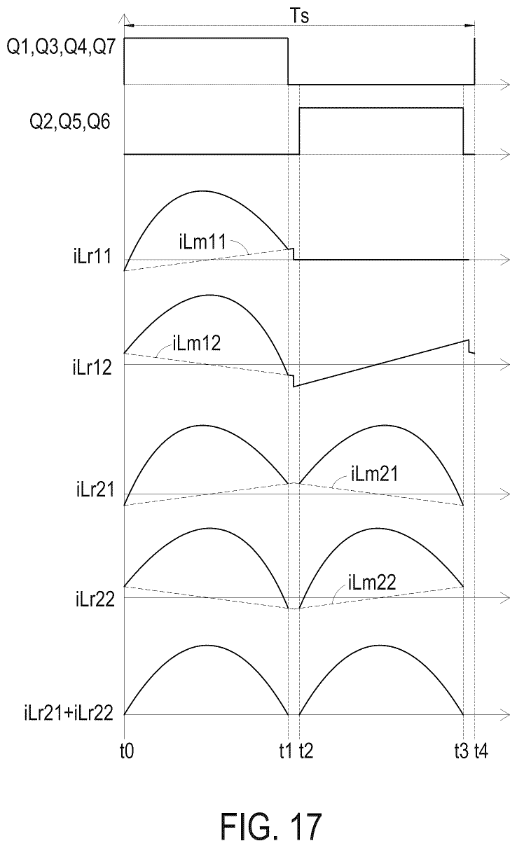

Please refer to FIGS. 14, 15, 16 and 17. FIG. 14 is a schematic circuit diagram illustrating the architecture of a power converter according to a third embodiment of the present disclosure. FIG. 15 is a schematic circuit diagram illustrating associated current paths of the power converter shown in FIG. 14, wherein the power converter is configured as a fifth resonant network. FIG. 16 is a schematic circuit diagram illustrating associated current paths of the power converter shown in FIG. 14, wherein the power converter is configured as a sixth resonant network. FIG. 17 is a schematic timing waveform diagram illustrating associated signals of the power converter shown in FIG. 14. Component parts and elements corresponding to those of the first embodiment are designated by identical numeral references, and detailed descriptions thereof are omitted.

In this embodiment, the buck circuit 20 of the power converter 1b includes a voltage clamp circuit 22 and a diode D1. The first terminal of the voltage clamp circuit 22 is electrically connected with the second terminal of the first switch Q1. The second terminal of the voltage clamp circuit 22 is electrically connected with the cathode of the diode D1. The anode of the diode D1 is electrically connected with the input negative terminal V2 of the buck circuit 20. In the power converter 1b of this embodiment, the rear-stage conversion circuit 3 is not equipped with the fourth switch Q4, and the second terminal of the first inductor L1 is electrically connected to the first terminal of the resonant capacitor Cr.

In an embodiment, the voltage clamp circuit 22 includes a first resistor R1 and a third capacitor C3, which are electrically connected with each other in parallel. The first resistor R1 and the third capacitor C3 in parallel connection are electrically connected between the second terminal of the first switch Q1 and the cathode of the diode D1.

In an embodiment, the first switch Q1, the third switch Q3, and the seventh switch Q7 receive a first control signal, and the second switch Q2, the fifth switch Q5 and the sixth switch Q6 receive a second control signal. As shown in FIG. 17, the phase shift between the first control signal and the second control signal is 180 degrees. Similarly, each of the second switch Q2, the third switch Q3, the fifth switch Q5, the sixth switch Q6 and the seventh switch Q7 has the switching period Ts. In addition, the turn-on duration of each of the first switch Q1, the second switch Q2 and the third switch Q3, the fifth switch Q5, the sixth switch Q6 and the seventh switch Q7 is smaller than one half of the switching period Ts.

Hereinafter, the operations of the power converter 1b will be illustrated with reference to FIGS. 14, 15, 16 and 17.

Please refer to FIG. 17. In the time interval between the time point to and the time point t1, the first switch Q1, the third switch Q3, and the seventh switch Q7 are turned on, and the second switch Q2, the fifth switch Q5 and the sixth switch Q6 are turned off. Meanwhile, the simplified circuitry topology of the power converter 1b can be seen in FIG. 15, and the power converter 1b is configured as a fifth resonant network.

As shown in FIG. 15, the non-dot terminal of the first inductor L1 and the dot-marked terminal of the second inductor L2 are short-circuited. In order to simplify the analysis, the influence of the first capacitor C1 is ignored here. There is a plurality of resonant currents in the power converter 1b. The resonant current iLr11 flows through the first inductor L1. The resonant current iLr22 flows through the second inductor L2. The resonant current iLr21 flowing through the first output inductor L3. The resonant current iLr22 flows through the second output inductor L4.

In addition, each resonant current includes two parts, i.e., a load current and an excitation current. The excitation current is determined according to the voltage across the two terminals of the inductor and the magnetizing inductance. In other words, the resonant current iLr11 includes the load current and the excitation current iLm11, the resonant current iLr12 includes the load current and the excitation current iLm12, the resonant current iLr21 includes the load current and the excitation current iLm21, and the resonant current iLr22 includes the load current and the excitation current iLm22. Due to the resonance of the resonant capacitor Cr and the resonant inductor Lr, the resonant currents iLr11, iLr12, iLr21 and iLr22 are generated. The equivalent resonant inductance Lr may be expressed as: Lr=Lk1/2+2×Lk2+Leq, where Lk1 is the leakage inductance of one of the first inductor L1 and the second inductor L2, Lk2 is the leakage inductance of one of the first output inductor L3 and the second output inductor L4, and Leq is the equivalent inductance about the parasitic inductance in the primary side traces of the front-stage conversion circuit 2 and the parasitic inductance in the secondary side traces of the rear-stage conversion circuit 3.

Under this circumstance, the non-dot terminal of the first inductor L1 and the dot-marked terminal of the second inductor L2 are connected with each other directly, and the dot-marked terminal of the first output inductor L3 and the non-dot terminal of the second output inductor L4 are connected with each other directly. Consequently, the excitation current iLm11 is equal to the reverse excitation current iLm12, the excitation current iLm21 is equal to the reverse excitation current iLm22, and the resonant current iLr21 is equal to the resonant current iLr22. The waveforms of these currents can be seen in FIG. 15.

In the equivalent circuit, the magnetizing inductances of the first inductor L1, the second inductor L2, the first output inductor L3 and the second output inductor L4 can be cancelled out. In addition, the leakage inductances of the first inductor L1, the second inductor L2, the first output inductor L3 and the second output inductor L4 can resonate with the resonant capacitor Cr. That is, in the time interval between the time point to and the time point t1, the resonance between the resonant capacitor Cr and the resonant inductor Lr of the power converter 1b generates the resonant currents iLr11, iLr12, iLr21 and iLr22. When the resonant currents iLr11, iLr12, iLr21 and iLr22 are respectively equal to the excitation currents iLm11, iLm12, iLm21 and iLm22, i.e., the load current is zero, the first switch Q1, the third switch Q3, and the seventh switch Q7 are turned off. Since the zero-current switching functions of these switches are achieved, the turn-off loss of the switches will be reduced, and the energy transfer efficiency of the power converter 1b will be enhanced. In the time interval between the time point t2 and the time point t3, the second switch Q2, the fifth switch Q5 and the sixth switch Q6 are turned on, and the first switch Q1, the third switch Q3, and the seventh switch Q7 are turned off. Meanwhile, the simplified circuitry topology of the power converter 1b can be seen in FIG. 16, and the power converter 1b is configured as a sixth resonant network.

The equivalent circuit is divided into a left part and a right part. Since the third switch Q3 is turned off, the left part includes the first inductor L1, the leakage inductance Lk1 of the first inductor L1, the third capacitor C3, the junction capacitance CD of the diode D1 and the second capacitor C2, and the right part includes the resonant capacitor Cr, the leakage inductance Lk2 of the first output inductor L3, the second output inductor L4, and the leakage inductance Lk2 of the second output inductor L4.

In the circuitry of the right part, the resonant capacitor Cr discharges electricity to the first output inductor L3 and the second output inductor L4. The circuitry of the right part is similar to that in the time interval between the time point t0 and the time point t1. Since the dot-marked terminal of the first output inductor L3 and the non-dot terminal of the second output inductor L4 are electrically connected with each other, the excitation current iLm21 flowing through the first output inductor L3 and the excitation current iLm22 flowing through the second output inductor L4 have the relationship: the excitation current iLm21 is equal to the reverse excitation current iLm22. In response to the resonance between the resonant capacitor Cr and the resonant inductor Lr, the resonant currents iLr21 and iLr22 are generated. The resonant inductance Lr may be expressed as: Lr=2×Lk2+Leq, where Lk2 is the leakage inductance of one of the first output inductor L3 and the second output inductor L4, and Leq is the equivalent inductance about the parasitic inductance in the primary side traces of the front-stage conversion circuit 2, the parasitic inductance in the secondary side traces of the rear-stage conversion circuit 3 and optionally the inductance of at least one external inductor (not shown). Consequently, the resonant current iLr21 flowing through the first output inductor L3 and the resonant current iLr22 flowing through the second output inductor L4 are equal. The waveforms of these currents in the time interval between the time point t2 and the time point t3 can be seen in FIG. 17.

In the equivalent circuit, the magnetizing inductances of the first output inductor L3 and the second output inductor L4 can be cancelled out. In addition, the leakage inductances of the first output inductor L3 and the second output inductor L4 can resonate with the resonant capacitor Cr.

That is, in the time interval between the time point t2 and the time point t3, the resonance between the resonant capacitor Cr and the resonant inductor Lr of the power converter 1b generates the resonant currents iLr21 and iLr22. When the resonant currents iLr21 and iLr22 are respectively equal to the excitation currents iLm21 and iLm22, i.e., the load current is zero, the first switch Q1, the third switch Q3, and the seventh switch Q7 are turned off. Since the zero-current switching (ZCS) functions of these switches are achieved, the turn-off loss of the switches will be reduced, and the energy transfer efficiency of the power converter 1b will be enhanced.

In the circuitry of the left part, the diode D1 is shut off in response to the reverse voltage. That is, the resonant current iLr11=0. Consequently, in this time interval, the first capacitor C1 discharges electricity to the second inductor L2 only. The resonant current iLr12 flowing through the second inductor L2 increases linearly. The waveforms of associated currents in the time interval between the time point t2 and the time point t3 can be seen in FIG. 17.

When the winding current of the second inductor L2 is equal to twice the excitation current iLm12 (i.e., the load current is zero), the second switch Q2, the fifth switch Q5 and the six-switch Q6 are turned off. Since the zero-current switching functions of these switches are achieved, the turn-off loss of the switches will be reduced, and the energy transfer efficiency of the power converter 1b will be enhanced.

Furthermore, in the time interval between the time point t2 and the time point t3, the voltage drop across the two terminals of the first switch Q1 is Vdc/2, the voltage drop across the two terminals of the seventh switch Q7 is Vdc/4, and the voltage drop across the two terminals of the third switch Q3 is 3Vdc/4. In the beginning of the interval from time t3 to time t4, the second switch Q2, the fifth switch Q5 and the sixth switch Q6 are turned off, and the excitation currents of the first inductor L1, the second inductor L2, the first output inductor L3 and the second output inductor L4 start to freewheel. In addition, the corresponding excitation currents reversely charge the parasitic capacitances at the two terminals of each of the first switch Q1, the third switch Q3, and the seventh switch Q7. Consequently, the drain-source voltages of the first switch Q1, the third switch Q3, and the seventh switch Q7 drop. When the drain-source voltages of the first switch Q1, the third switch Q3, and the seventh switch Q7 drop to be lower than 50% of the initial voltage, the first switch Q1, the third switch Q3, and the seventh switch Q7 are turned on. Then, the next switching period is started. Consequently, the turn-on loss of the switches will be reduced, and the energy transfer efficiency of the power converter 1b will be enhanced. Furthermore, when the drain-source voltages of these switches drop to zero, the first switch Q1, the third switch Q3, and the seventh switch Q7 are turned on. Since the zero-voltage switching functions of these switches are achieved, the turn-on loss of the switches will be reduced, and the energy transfer efficiency of the power converter 1b will be enhanced.

Like the power converter 1 shown in FIG. 3, the power converter 1b of this embodiment can be operated in four situations shown in FIGS. 6, 7, 8 and 9. The operations of the power converter 1b in some situations will be illustrated with the waveforms of FIG. 17 as well as FIGS. 6, 7, 8 and 9.

In the above embodiments, the switches are semiconductor switches, e.g., metal oxide semiconductor field effect transistors (MOS), silicon carbide (SiC) or gallium nitride (GaN).

From the above embodiments, the present disclosure provides a power converter. In the buck circuit of the front-stage conversion circuit, the first inductor and the second inductor of the auxiliary circuit are negative coupling. In the rear-stage conversion circuit, the dot-marked terminal of one of the first output inductor and the second output inductor is connected with the non-dot terminal of the other of the first output inductor and the second output inductor. Consequently, the large inductance of the inductor in the front-stage conversion circuit can be offset. In response to the leakage inductances of the first inductor and the second inductor in the front-stage conversion circuit, the parasitic inductance in the wiring and the resonance generated by the resonant capacitor, zero-current switching functions of the switches in the front-stage conversion circuit can be achieved, and the energy transfer efficiency of the power converter will be enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power converter, comprising:
a front-stage conversion circuit comprising a buck circuit and an auxiliary circuit, wherein the buck circuit comprises a first inductor, a first switch and a first capacitor, and the auxiliary circuit comprises a second inductor, wherein a first terminal of the first inductor is electrically connected to an input positive terminal of the buck circuit through the first switch, a second terminal of the first inductor is electrically connected to an output positive terminal of the buck circuit, the first capacitor is electrically connected between the output positive terminal and an output negative terminal of the buck circuit, and the second inductor of the auxiliary circuit and the first inductor are negative coupling; and
a rear-stage conversion circuit comprising a resonant capacitor, a first output inductor and a second output inductor, wherein the first output inductor and the second output inductor are negative coupling, and a dot-marked terminal of the first output inductor is connected with a non-dot terminal of the second output inductor and electrically connected with an output positive terminal of the power converter, an input positive terminal of the rear-stage conversion circuit is electrically connected to the output positive terminal of the buck circuit, and an input negative terminal of the rear-stage conversion circuit is electrically connected to the output negative terminal of the buck circuit,
wherein the auxiliary circuit is electrically connected between an input negative terminal of the buck circuit and the resonant capacitor of the rear-stage conversion circuit.

2. The power converter according to claim 1, wherein the first switch is operated at an operating frequency, wherein in a time interval no longer than one half of a switching period of the first switch, a resonant network is formed in the power converter, wherein the resonant network comprises the first inductor, the second inductor, the resonant capacitor, the first output inductor and the second output inductor.

3. The power converter according to claim 2, wherein the power converter has a resonant frequency and a resonant period related to the resonant capacitance, wherein the resonant period is higher than or equal to the switching period.

4. The power converter according to claim 3, wherein resonant currents flow through the first output inductor and the second output inductor, and a frequency of each of the resonant currents is lower than the operating frequency of the first switch.

5. The power converter according to claim 3, wherein the switching period is divided into a first sub-period and a second sub-period, and the first sub-period is earlier than the second sub-period, wherein in the first sub-period, a first resonant current flows through the first output inductor, a second resonant current flows through the second output inductor, and a frequency of each of the first resonant current and the second resonant current is lower than the operating frequency of the first switch, wherein the first resonant current and the second resonant current flow to a load through the output positive terminal and an output negative terminal of the power converter to transfer electric energy to the load, wherein in the second sub-period, a resonant current flowing through one of the first inductor and the second inductor is zero, and twice an excitation current flows through the other of the first inductor and the second inductor.

6. The power converter according to claim 1, wherein the auxiliary circuit further comprises a series branch, wherein a first terminal of the series branch is electrically connected with the output negative terminal of the buck circuit, and a second terminal of the series branch is electrically connected with the resonant capacitor.

7. The power converter according to claim 6, wherein from the first terminal to the second terminal of the series branch, the series branch comprises a second switch, a second capacitor and a third switch sequentially connected in series, wherein a first terminal of the second inductor is electrically connected with an input negative terminal of the buck circuit, and a second terminal of the second inductor is electrically connected to a node between the second capacitor and the third switch.

8. The power converter according to claim 7, wherein the rear-stage conversion circuit further comprises a fourth switch, a fifth switch, a sixth switch and a seventh switch, wherein a first terminal of the fourth switch is electrically connected with the input positive terminal of the rear-stage conversion circuit, a second terminal of the fourth switch is electrically connected with a first terminal of the resonant capacitor, a first terminal of the fifth switch is electrically connected with a second terminal of the resonant capacitor, a second terminal of the fifth switch is electrically connected with the input negative terminal of the rear-stage conversion circuit, a first terminal of the sixth switch is electrically connected with the first terminal of the resonant capacitor, a second terminal of the sixth switch is electrically connected with a first terminal of the seventh switch, and a second terminal of the seventh switch is electrically connected with a negative output terminal of the power converter, wherein the second terminal of the series branch is electrically connected with the first terminal of the resonant capacitor.

9. The power converter according to claim 8, wherein the first switch, the third switch, the fourth switch and the seventh switch receive a first control signal, and the second switch, the fifth switch and the sixth switch receive a second control signal, and a phase shift between the first control signal and the second control signal is 180 degrees, wherein a turn-on duration of each of the first switch, the second switch, the third switch, the fourth switch, the fifth switch, the sixth switch and the seventh switch is smaller than one half of the switching period.

10. The power converter according to claim 8, wherein the switching period includes a first dead time segment and a second dead time segment, wherein the first dead time segments is between the first sub-period and the second sub-period, the second sub-period is followed by the second dead time segment, and a time length of the first dead time segment and a time length of the second dead time segment are equal, wherein in the first dead time segment and the second dead time segment, the first switch, the second switch, the third switch, the fourth switch, the fifth switch, the sixth switch and the seventh switch are turned off, and parasitic capacitors of the first switch, the third switch, the fourth switch, the seventh switch, the second switch, the fifth switch and the sixth switch are charged or discharged in response to excitation currents flowing through the first inductor, the second inductor, the first output inductor and the second output inductor.

11. The power converter according to claim 1, wherein the buck circuit comprises a voltage clamp circuit and a diode, wherein a first terminal of the voltage clamp circuit is electrically connected with the first switch, a second terminal of the voltage clamp circuit is electrically connected with a cathode of the diode, and an anode of the diode is electrically connected with the input negative terminal of the buck circuit.

12. The power converter according to claim 11, wherein the voltage clamp circuit comprises a first resistor and a third capacitor, which are electrically connected with each other in parallel, wherein the first resistor and the third capacitor in parallel connection are electrically connected between the first switch and the cathode of the diode.

13. The power converter according to claim 11, wherein the rear-stage conversion circuit further comprises a fifth switch, a sixth switch and a seventh switch, wherein a first terminal of the resonant capacitor is electrically connected to the input positive terminal of the rear-stage conversion circuit, a first terminal of the fifth switch is electrically connected to a second terminal of the resonant capacitor, a second terminal of the fifth switch is electrically connected with the input negative terminal of the rear-stage conversion circuit, a first terminal of the sixth switch is electrically connected with the first terminal of the resonant capacitor, a second terminal of the sixth switch is electrically connected with a first terminal of the seventh switch, and a second terminal of the seventh switch is electrically connected to a negative output terminal of the power converter.

14. The power converter according to claim 1, wherein the auxiliary circuit comprises a parallel branch, and the parallel branch comprises a second capacitor, a second switch and a third switch, wherein the second switch and the second capacitor are connected with each other in series, and a series-connected structure of the second switch and the second capacitor is connected with the third switch in parallel, wherein a first terminal of the parallel branch is electrically connected with the output negative terminal of the buck circuit, a second terminal of the parallel branch is electrically connected with a first terminal of the second inductor, and a second terminal of the second inductor is electrically connected with the first terminal of the resonant capacitor.

15. The power converter according to claim 1, wherein a coupling coefficient about the first inductor and the second inductor is less than −0.9, and a coupling coefficient about the first output inductor and the second output inductor is less than −0.9.

16. The power converter according to claim 1, wherein a turn ratio of a winding of the first inductor to a winding of the second inductor is 1:1.
